(19) United States
(12) Patent Application Publication
(10) Pub. No.: US 2009/0247360 A1
(43) Pub. Date: Oct. 1, 2009

(54) Linear Engine

(76) Inventors: Morris Ben-Shabat, Moshav Emunim (IL); Jack Ben-Shabat, Moshav Emunim (IL)

Correspondence Address: HAIM FACTOR;Ofek Group Inc., 16192 Coastal Highway, Lewes, DE, 19958, US

(21) Appl. No.: 12/055,831

(22) Filed: Mar. 26, 2008

(51) Int. Cl. B60W 10/04

(52) U.S. Cl. 477/115

(57) ABSTRACT

In one embodiment, the present invention is directed to a linear engine comprising: a piston; a linear piston leg comprising two opposite cogged edges including: lowering cogs and raising cogs; at least one lowering segmental cogwheel, the cogs of which correspond to said cogs of one edge of said linear piston leg; at least one raising segmental cogwheel, the cogs of which correspond to said cogs of one edge of said linear piston leg; and a transmission system connecting said cogwheels to a driveshaft; wherein each of said segmental cogwheels comprising at least two opposite cogged segments and two opposite cogless segments.

### FIELD OF THE INVENTION

The present invention relates to linear transmission of power in an engine and in particular to linear transmission of power in an internal combustion engine or a compressor.

### BACKGROUND OF THE INVENTION

Most existent internal combustion engines and compressors are operated by pistons which activate piston legs that rotate a driveshaft. Such engines and compressors have a great deal of energy loss, also for the following two reasons:
a. The piston leg's angular movement, which generates energy loss due to its lateral movement component, perpendicular to the longitudinal movement of the piston.
b. Seeing as the engine includes an ex-centric wheel, generates energy loss too.
c. The time interval between each ignition is long due to the ex-centric movement.

Furthermore, these engines have additional disadvantages, such as the following: The engine is subject to unnecessary wear within the piston housing, which shortens its life span, seeing as the combustion chambers in these engines are eroded in an oval shape due to the pressure of the crankshaft arm, mostly in the area of ascending.

The present invention refers to linear transmission of movement in internal combustion engines and compressors, which achieves significant efficiency by converting the piston's linear movement into rotational movement of the flywheel at an adaptable rate.

Mechanisms for linear transmission of power from a piston which has a leg or a piston leg mounted with a linear cogged strip or strips, connected to one or more cogwheels.

Examples of such mechanisms can be found in the following list of U.S. patents:

U.S. Pat. No. 4,941,396 of McCabe, ‘Reciprocating double-ended piston”; and

U.S. Pat. No. 5,934,243 of Kopystanski, ‘Drive mechanism for a reciprocating piston engine’, which is incorporated by reference for all purposes as if fully set forth herein.

FIG. 3 of U.S. Pat. No. 4,941,396 of McCabe shows a schematic side view of a double-ended piston with a pair of engaged double-ended piston shafts, in a cylinder arrangement.

The illustration also shows two double-ended piston rakes, and one double-ended piston gear next to each of both double-ended piston rakes.

FIG. 4 of U.S. Pat. No. 4,941,396 of McCabe is schematic top view of the same arrangement.

FIG. 10 of U.S. Pat. No. 4,941,396 of McCabe is a perspective view of the engaged double-ended piston shaft which is driven by the reciprocating double-ended pistons of the same arrangement, which is connected to a double-ended piston gear.

A description of the method of operation of the mechanism, and particularly of the power transmission, can be found in U.S. Pat. No. 4,941,396, however, note that for every cycle of two strokes of double-ended piston, double-ended piston gear performs a complete revolution (of 360 degree) with the engaged double-ended piston shaft.

An obvious disadvantage is that the double-ended piston gear is actually a cogwheel, which is in approximately half of its circumference, cogged, while the other half is not and is smooth. This structure causes the wheel to be imbalanced around its symmetry axis, causing undesired inertial loads during the engine's operation.

An additional disadvantage of the double-ended piston engine is the imbalance, which can cause vibrations, due to the high mass moving back and forth within the cylinder.

FIG. 1 of U.S. Pat. No. 5,934,243 of Kopystanski is a perspective illustration of an improved drive mechanism for a reciprocating piston engine.

The main components shown in the illustration are the reciprocating engine piston, piston leg, power drive gear, and the power driveshaft.

FIG. 2 of U.S. Pat. No. 5,934,243 of Kopystanski is an end plan view of the improved drive mechanism for a reciprocating piston engine, as viewed from the left. This illustration also shows the power rack gear and the clutch.

A description of the method of operation of the mechanism, and particularly of the power transmission, can be found in U.S. Pat. No. 5,934,243, however, note that there is a similar disadvantage here to that of the mechanism according to the previous patent, and that the power drive gear is not balanced on its symmetry axis. In this mechanism, the teeth of both of the power drive gears, are engaged with the teeth of the power rack gears, and clutch ensures that during movement of the piston in one direction, the rotation moment will be transmitted to power driveshaft, and during movement of the piston in the other direction, the power driveshaft is free to move in the same direction. Namely, both power drive gears perform vibrational movement, while both clutches also work in perpetual cyclic motion, while the engine is running.

The operation of this mechanism is typically cumbersome, expensive, and at a high rate of wear relative to practical engines.

There is therefore a need for internal combustion engines and compressors which, relative to standard engines and compressors, conserve energy, significantly reduce wear, take up less volume, and are more efficient with better output.

### SUMMARY OF THE INVENTION

The present invention relates to linear power transmission in an engine and, in particular to linear power transmission in an internal combustion engine or compressor.

According to the present invention, linear power transmission in a engine engages a piston, with a cogged arm, to two segmental cogwheels, with each segmental cogwheel having four segments, two opposite segments having teeth and two smooth opposite segments without teeth, which transmit rotational movement to two full cogwheels transmitting (or receiving) rotational movement to a single cogwheel rotating a flywheel.

Additional objects and advantages of the invention will be set forth in part in the description which follows and, in part, will be obvious from the description, or may be learned by practice of the invention.

According to the present invention there is provided a linear engine including: (a) a piston; (b) a linear piston leg comprising two opposite cogged edges including: (i) lowering cogs; and (ii) raising cogs; (c) at least one lowering segmental cogwheel, the cogs of which correspond to the cogs of one edge of the linear piston leg; (d) at least one raising segmental cogwheel, the cogs of which correspond to the cogs of one edge of the linear piston leg; and (e) a transmission system connecting said cogwheels to a driveshaft; wherein each of said segmental cogwheels comprising at least two opposite cogged segments and two opposite cogless segments.

According to further features in the described embodiments of the invention the linear piston leg, the lowering cogs, and the raising cogs are so arranged that the lowering cogs can be engaged with the cogged segment of the lowering segmental cogwheel, wherein the raising cogs can be engaged with the cogged segment of the raising segmental cogwheel, and wherein when the cogged segment of the lowering segmental cogwheel is engaged with the lowering cogs, the cogged segment of the raising segmental cogwheel is not engaged with the raising cogs.

According to still further features in the described embodiments the linear piston leg is not disposed to a second piston.

According to still further features in the described embodiments the linear piston leg further includes: (iii) a lead groove, wherein the lead groove has linear orientation to the movement direction of the linear piston leg.

According to still further features in the described embodiments the linear engine further including: (f) a piston lowering driveshaft disposed on the lowering segmental cogwheel; (g) a piston lowering driveshaft connective cogwheel disposed on the piston lowering driveshaft, wherein the lowering segmental cogwheel, the piston lowering driveshaft, and the piston lowering driveshaft connective cogwheel have a common rotational axis; (h) a piston raising driveshaft disposed on the raising segmental cogwheel; and (i) a piston raising driveshaft connective cogwheel disposed on the piston raising driveshaft, wherein the raising segmental cogwheel, the piston raising driveshaft, and the piston lowering raising connective cogwheel have a common rotational axis.

According to still further features in the described embodiments the linear engine further including: (j) a rotational direction reversing cogwheel; (k) a main driveshaft; and (l) a flywheel, wherein the rotational direction reversing cogwheel, the main driveshaft, and the flywheel have a common rotational axis.

According to still further features in the described embodiments the linear engine further including: (m a transmission housing, including: (i) a transmission housing front wall having a front opening, wherein the main driveshaft passes through the front opening; (ii) a transmission housing rear wall connected to the transmission housing front wall, the transmission housing rear wall at least partially having an upper opening, wherein the linear piston leg passes through the upper opening; (iii) a front transmission housing cover disposed on the transmission housing front wall; and (iv) a rear transmission housing cover disposed on the transmission housing rear wall.

According to still further features in the described embodiments the linear engine further including: (n) a cylinder disposed partially on the transmission housing front wall, and partially on the transmission housing rear wall.

According to still further features in the described embodiments the linear engine further including: (o) a lead disposed on the rear transmission housing cover.

### BRIEF DESCRIPTION OF THE DRAWINGS

The invention is herein described, by way of example only, with reference to the accompanying drawings, wherein:

FIG. 1 is a front perspective view schematic illustration of an exemplary, illustrative embodiment of a linear engine, according to the present invention.

FIG. 2 is a rear perspective view schematic illustration of an exemplary, illustrative embodiment of the linear engine, when the transmission housing is open and the cylinder is separated from the piston, according to the present invention.

FIG. 3 is a front perspective view schematic illustration of an exemplary, illustrative embodiment of the linear engine, when the transmission housing is open and the cylinder is separated from the piston, according to the present invention.

FIG. 4 is a front perspective schematic illustration of an exemplary, illustrative embodiment of a transmission system of the linear engine, according to the present invention.

FIG. 5 is a rear view schematic illustration of an exemplary, illustrative embodiment of the piston, a linear piston leg, and two segmental cogwheels, of the linear engine, when the piston is descending, according to the present invention.

FIG. 6 is a rear view schematic illustration of an exemplary, illustrative embodiment of the piston, a linear piston leg, and two segmental cogwheels, of the linear engine, when the piston is ascending, according to the present invention.

### DETAILED DESCRIPTION OF EMBODIMENTS

The present invention is of a linear engine.

The principles and operation of a linear engine according to the present invention may be better understood with reference to the drawings and the accompanying description.

Before explaining at least one embodiment of the invention in detail, it is to be understood that the invention is not limited in its application to the details of construction and the arrangement of the components set forth in the following description or illustrated in the drawings.

Unless otherwise defined, all technical and scientific terms used herein have the same meaning as commonly understood by one of ordinary skill in the art to which this invention belongs. The materials, dimensions, methods, and examples provided herein are illustrative only and are not intended to be limiting.
The following list is a legend of the numbering of the application illustrations: 08260 List

34 flywheel

36a transmission housing front wall

36b transmission housing rear wall

38 cylinder

40 engine head

42 piston

44 piston pin

46 linear piston leg

48 lead groove (for the linear piston leg)

50 lowering cogs

52 raising cogs

56a raising segmental cogwheel

56b cogless segment of the raising segmental cogwheel

56c cogged segment of the raising segmental cogwheel

58a lowering segmental cogwheel

58b cogless segment of the lowering segmental cogwheel

58c cogged segment of the lowering segmental cogwheel

62 first bearing (for the piston lowering driveshaft)

64 piston lowering driveshaft

66 piston raising driveshaft

68 second bearing (for the piston raising driveshaft)

70f front transmission housing cover

70r rear transmission housing cover

72 piston raising driveshaft connective cogwheel

74 piston lowering driveshaft connective cogwheel

76 rotational direction reversing cogwheel

78 third bearing (for the piston raising driveshaft)

80 fourth bearing (for the piston lowering driveshaft)

82 fifth bearing (for the main driveshaft)

84f front opening (for the main driveshaft)

84u upper opening (for the linear piston leg)

86 lead (for the linear piston leg)

88d arrow indicating piston downwards motion

88u arrow indicating piston upwards motion

90 main driveshaft

100 linear engine (according to the present invention)

As used herein the specification and in the claims section that follows, the term “linear piston leg” and the like refer to a piston leg, which is substantially incapable of performing non-linear movement.

As used herein the specification and in the claims section that follows, the term “linear engine” and the like refer to an engine which substantially includes a piston connected to a linear piston leg.

In the present patent application, the use of terms regarding upwards and downwards directions, as well as the terms lowering and raising, refers to the position of the linear engine in the illustrations of the application, and does not in any way limit use of the linear engine according to the present invention from use in other positions relative to the horizon.

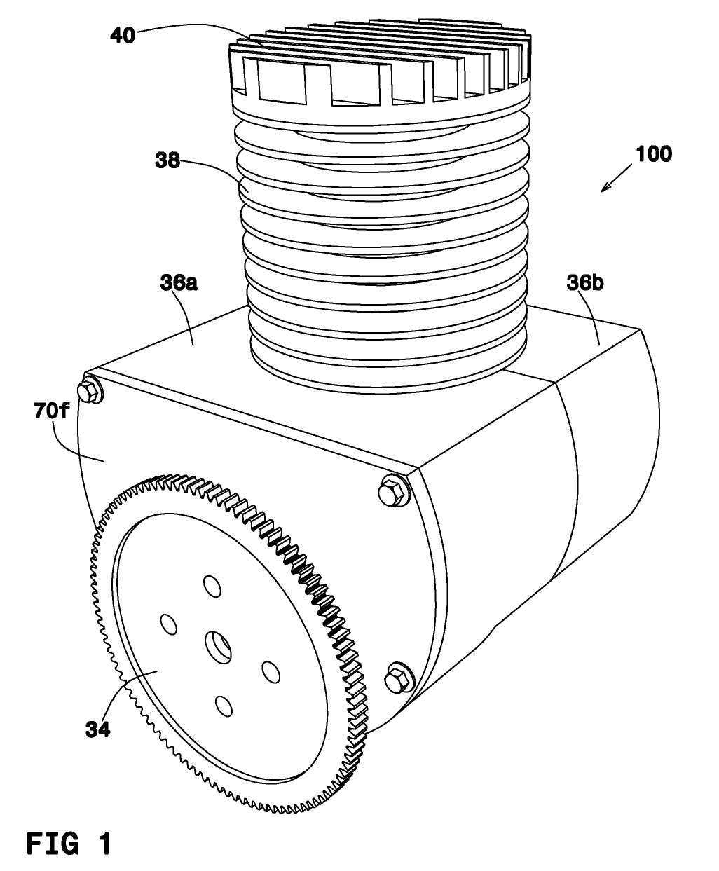

Referring now to the drawings, FIG. 1 is a front perspective view schematic illustration of an exemplary illustrative embodiment of a linear engine 100, according to the present invention.

This view shows the linear engine 100, from outside, for its main parts which are cylinder 38, with an engine head 40, a flywheel 34, and a transmission housing, which can be constructed in several methods, the one shown in the present illustration including a transmission housing front wall 36a, a transmission housing rear wall 36b, and two covers, one of which, the front transmission housing cover 70f, is shown in the illustration. In another optional method, the transmission housing rear wall 36b can include a rear transmission housing cover as a single integrated part.

According to the present invention the linear engine 100 can include, as shown in the present illustration, one cylinder 38 (containing one piston). In other configurations, linear engine 100 can include more than one cylinder 38, in which case of course it will also include other components, which will be described in further illustrations, in the required quantity.

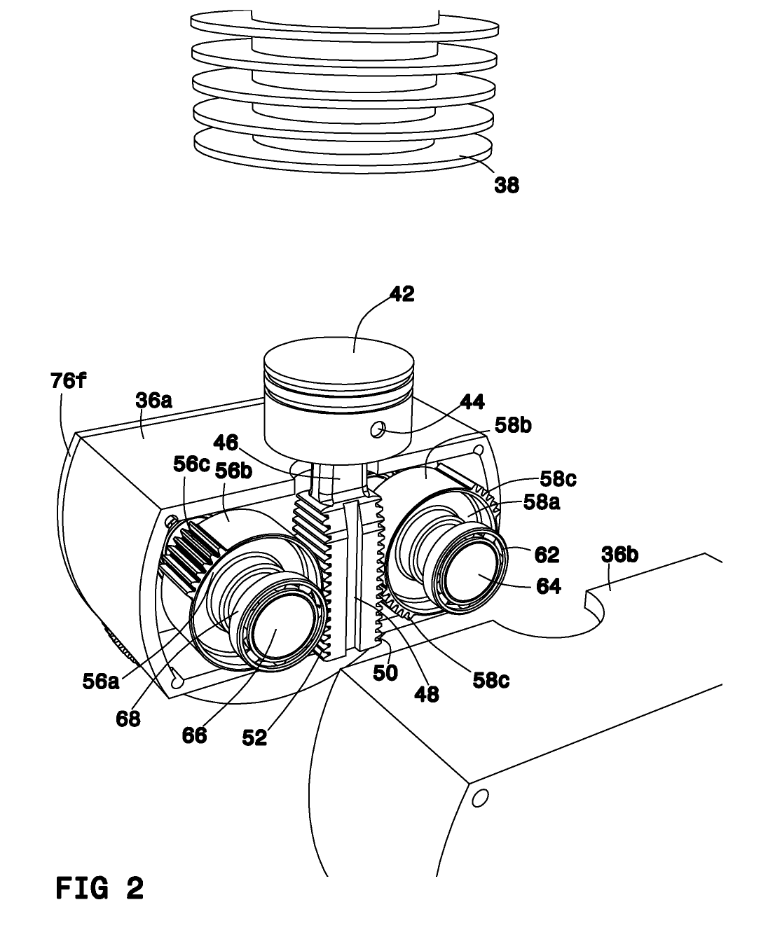

FIG. 2 is a rear perspective view schematic illustration of an exemplary, illustrative embodiment of the linear engine 100, when the transmission housing is open. The transmission housing front wall 36a is distant from the transmission housing rear wall 36b, and the piston 42 is outside of cylinder 38, according to the present invention. This view shows piston 42 which is connected to a linear piston leg 46. In the present case, the connection is by means of a piston pin 44, however it can also be by other means, with the connection being rigid without any ability of any kind of movement between piston 42 and the linear piston leg 46, and can even be made as a single unit with the linear piston leg 46.

Linear piston leg 46 can also include a device for preventing latitudinal movement, namely for preventing movement in a direction other than the movement direction of the piston 42. This illustration shows such a device in the form of lead groove 48. On one side of the linear piston leg 46 is a row of lowering teeth 50, while on the other side is a row of raising teeth 52.

Lowering teeth 50 can be engaged with the cogged segment of the lowering segmental cogwheel 58c, and raising teeth 52 can be engaged with the cogged segment of the raising segmental cogwheel 56c, for the purpose of transmitting movement to and from piston 42, as will be further described.

Raising segmental cogwheel 56a transmits rotational movement to and receives rotational movement from piston raising driveshaft 66, and lowering segmental cogwheel 58a transmits rotational movement to and receives rotational movement from piston lowering driveshaft 64.

Use of segmental cogwheels with two cogged segments per cogwheel, as opposed to use of segmental cogwheels with a single cogged segment per cogwheel, enables use of a shorter linear piston leg. It is also possible to use segmental cogwheels with more than two cogged segments.

Clearly, this affects the working volume of the engine, for a piston of a given radius.

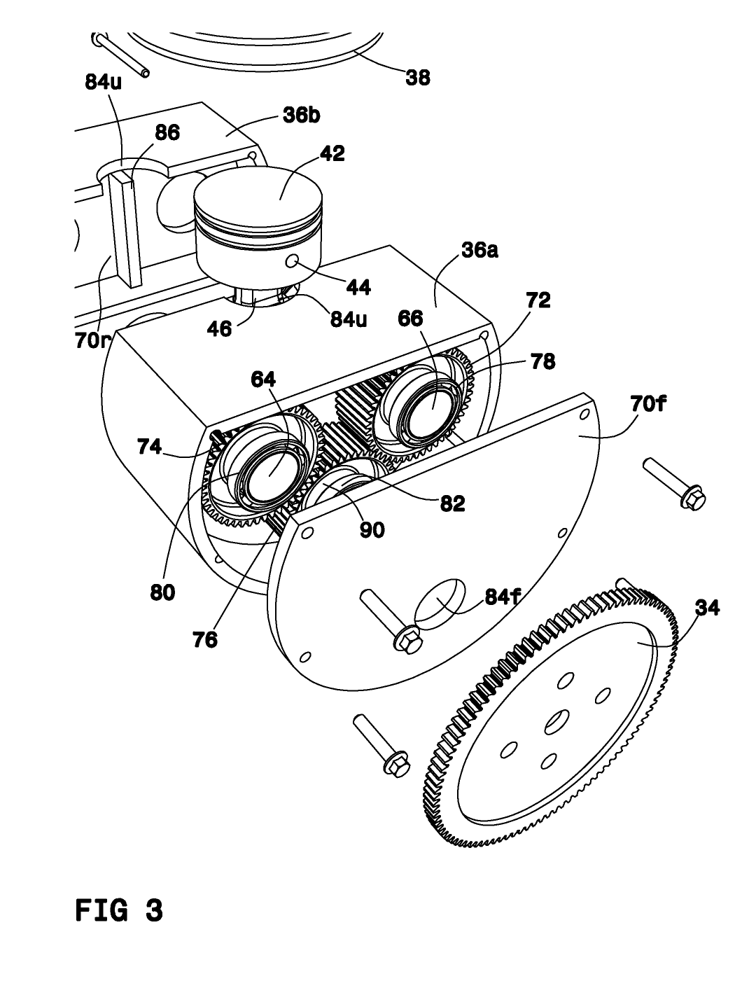

FIG. 3 is front perspective view schematic illustration of an exemplary, illustrative embodiment of the linear engine 100, when the transmission housing is open and the cylinder 38 is separated from the piston 42, according to the present invention. Within the transmission housing, on one side there are the piston lowering driveshaft 64, a piston lowering driveshaft connective cogwheel 74, and fourth bearing 80, supported the piston lowering driveshaft 64, while on the other side there are the piston raising driveshaft 66, a piston raising driveshaft connective cogwheel 72, and third bearing 78, supported the piston raising driveshaft 66. Both of these transmission systems are engaged with a rotational direction reversing cogwheel 76, connected by means of main driveshaft 90 to the flywheel 34, and is supported by fifth bearing 82.

Front opening 84f, for the main driveshaft 90, is in front transmission housing cover 70f. At the top parts of transmission housing front wall 36a and transmission housing rear wall 36b, there is an upper opening 84u through which the linear piston leg 46 passes and upon which cylinder 38, within which piston 42 can move, is assembled.

The illustration also shows rear transmission housing cover 70r, which as noted can also be an integrated part of transmission housing rear wall 36b, upon which lead 86, for the linear piston leg, is mounted, with dimensions suitable for lead groove 48 to prevent latitudinal movement of the linear piston leg 46.

According to the present invention, each engine will have one system of piston raising driveshaft connective cogwheel 72, piston lowering driveshaft connective cogwheel 74, engaged with a rotational direction reversing cogwheel 76, which rotates flywheel 34, independently of the number of pistons in the engine.

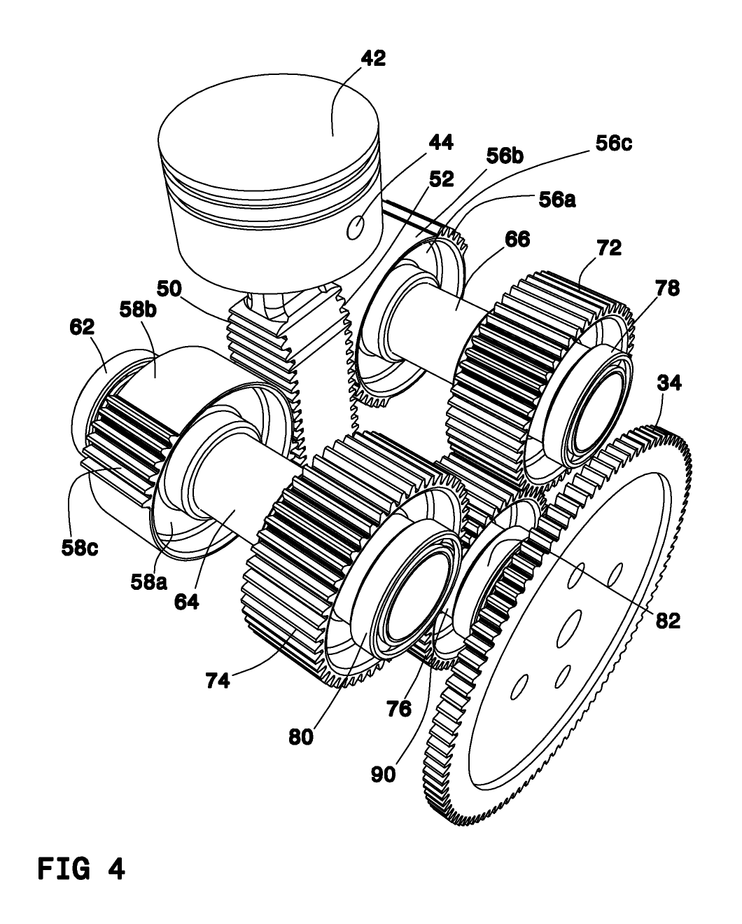

FIG. 4 is a front perspective view schematic illustration of an exemplary illustrative embodiment of a transmission system of the linear engine 100, according to the present invention.

This view shows the entire transmission, and the method of transmitting rotational movement.

Raising segmental cogwheel 56a is connected to piston raising driveshaft 66, and engaged with piston raising driveshaft connective cogwheel 72, which is engaged with rotational direction reversing cogwheel 76, connected by means of the main driveshaft 90 to the flywheel 34. Thus, rotational movement of the flywheel 34, will cause ascent of the piston 42 if the cogged segment of the raising segmental cogwheel 56c is in an engaged state with the raising teeth 52. In the other side the lowering segmental cogwheel 58a is connected to the piston lowering driveshaft 64, which is connected the piston lowering driveshaft connective cogwheel 74 which is in an engaged state with the rotational direction reversing cogwheel 76. Thus, the rotational movement of the flywheel 34 will cause descent of the piston 42 when the cogged segment of the lowering segmental cogwheel 58c is in an engaged state with the lowering teeth 50, and it is also clear that descent of the piston 42 will cause rotation of the flywheel 34 in this state, transmitting the motion to the engine main shaft 90.

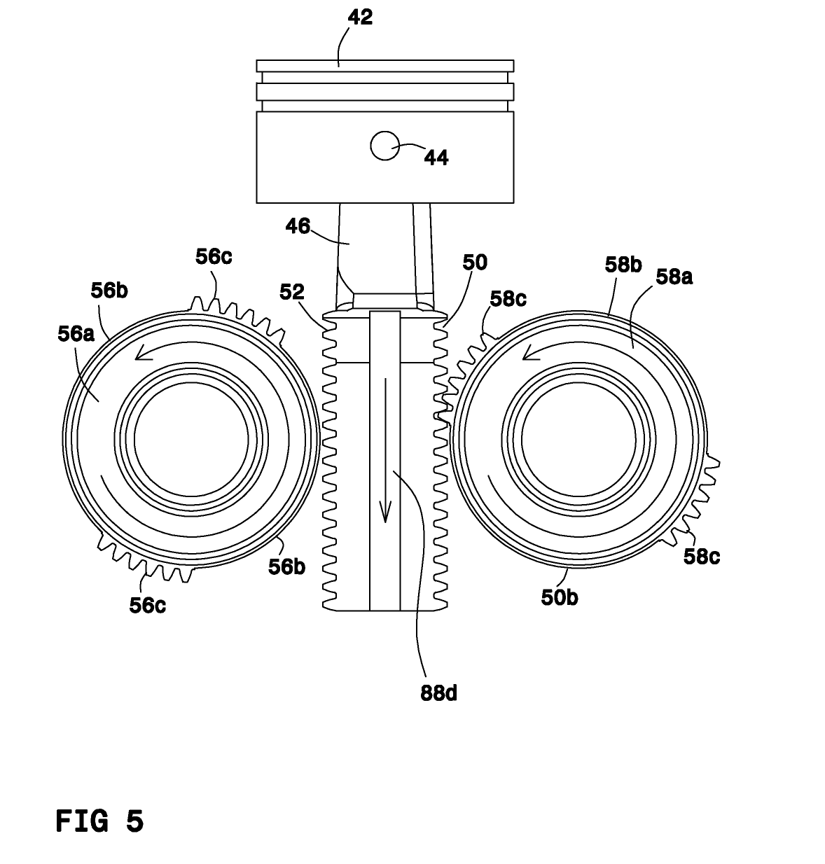

FIG. 5 is a rear view schematic illustration of an exemplary illustrative embodiment of the piston 42, the linear piston leg 46, the raising segmental cogwheel 56a, and the lowering segmental cogwheel 58a, of the linear engine 100, when the piston 42 is descending, according to the present invention. The illustration shows that one of the two cogged segments 58c of the lowering segmental cogwheel 58a is in an engaged state with the lowering teeth 50, while the cogless segment of the raising segmental cogwheel 56b is not in an engaged state with the raising teeth 52, with one of the cogless segments of the raising teeth cogwheel 56b, whose diameter is sufficiently small not to be touching the linear piston leg 46 from its position and not affecting its movement, facing the linear piston leg 46.

In this state, if the piston 42 descends during the engine's working stroke, namely during the expansion stroke, the majority of power transmission in the system shown in the present illustration is from the linear piston leg 46 to the lowering segmental cogwheel 58a, converting linear movement to rotational movement. The raising segmental cogwheel 56a keeps rotating during the entire process, also affected by the flywheel 34.

If the piston 42 descends during a stroke which is not a working stroke, such as the intake stroke, the transmission of power is from the lowering segmental cogwheel 58a to the linear piston leg 46.

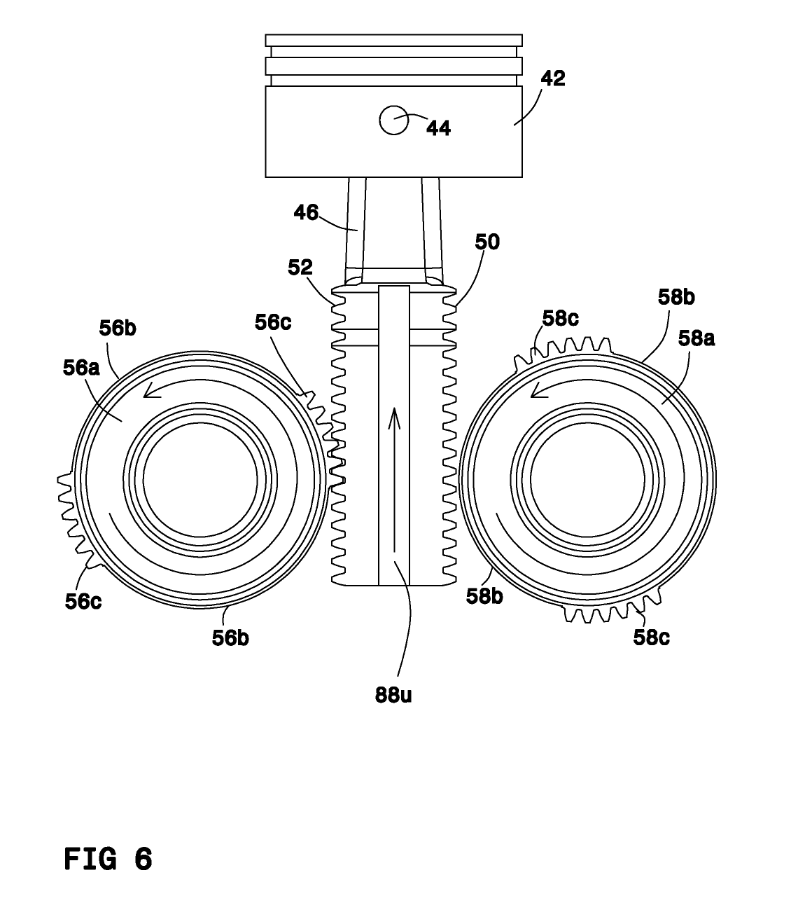

FIG. 6 is a rear view schematic illustration of an exemplary illustrative embodiment of the piston 42, the linear piston leg 46, the raising segmental cogwheel 56a, and the lowering segmental cogwheel 58a, of the linear engine 100, when the piston 42 is ascending, according to the present invention.

The illustration shows that one of the two cogged segments 56c of the raising segmental cogwheel 56a is in an engaged state with the raising teeth 52, while the cogged segment of the lowering segmental cogwheel 58c is not in an engaged state with the raising teeth 50, with one of the cogless segments of the lowering segmental cogwheel 58b, whose diameter is sufficiently small not to be touching the linear piston leg 46 from its position and not affecting its movement, facing the linear piston leg 46.

In this state, which is suitable for non-working strokes, such as compression and exhaust strokes, the power is transmitted from the raising segmental cogwheel 56a to the linear piston leg 46.

Both segmental cogwheels, the raising segmental cogwheel 56a and the lowering segmental cogwheel 58a, can be practically identical, and in any case each one is well balanced without any vibration caused during rotation around its symmetry axis as a result of imbalance of mass distribution, as may be the case in wheels that are not balanced.

Each of the segmental cogwheels, the raising segmental cogwheel 56a and the lowering segmental cogwheel 58a, performs at least one complete revolution for every four strokes of the engine, and when the transmission transmits the rotational movement to the main engine shaft 90 without any change in the transmission rate, this linear engine 100 generates one revolution for every four strokes of the piston 42.

In another exemplary embodiment of the present invention, the raising segmental cogwheel 56a and the lowering segmental cogwheel 58a, are disposed one above the other, both on one side of the linear piston leg 46, which in this case could have just one assembled row of teeth some of which serve as lowering teeth 50, some of serve as raising teeth 52, and some of which serve as both.

According to the present invention, linear power transmission can also be used in the linear engine at a variable transmission rate, as determined by the manufacturer or designer.

One of the main advantages of the present invention is that there is no need for a timing belt, seeing as the rotation rate of the linear engine is predetermined by two cogwheels, as described in the specification. An additional important advantage of the present invention is that the linear power transmission of the linear engine drastically reduces the necessary number of components, relative to the standard numbers of components in piston engines, reduces the degree of wear of components and the points of friction, and reduces the volume and weight of the engine.

In addition, the performance of the engine, according to the present invention, is higher, enabling output that is higher than the standard for an engine of the same volume or alternatively use of an engine which is smaller and lighter than the standard for a specific required output. The output of a given engine according to the present invention can be increased or decreased by simply altering the ratio of the cogwheels.

While the invention has been described with respect to a limited number of embodiments, it will be appreciated that many variations, modifications and other applications of the invention may be made.

What is claimed is:

1. A linear engine comprising:
(a) a piston;
(b) a linear piston leg comprising two opposite cogged edges including:
(i) lowering cogs; and
(ii) raising cogs;
(c) at least one lowering segmental cogwheel, the cogs of which correspond to said cogs of one edge of said linear piston leg;
(d) at least one raising segmental cogwheel, the cogs of which correspond to said cogs of one edge of said linear piston leg; and
(e) a transmission system connecting said cogwheels to a driveshaft; wherein each of said segmental cogwheels comprising at least two opposite cogged segments and two opposite cogless segments.

2. The linear engine of claim 1, wherein said linear piston leg, said lowering cogs, and said raising cogs are so arranged that said lowering cogs can be engaged with said cogged segment of said lowering segmental cogwheel, wherein said raising cogs can be engaged with said cogged segment of said raising segmental cogwheel, and wherein when said cogged segment of said lowering segmental cogwheel is engaged with said lowering cogs, and said cogged segment of said raising segmental cogwheel is not engaged with said raising cogs.

3. The linear engine of claim 2, wherein said linear piston leg is not disposed to a second piston.

4. The linear engine of claim 3, wherein said linear piston leg further includes:
(iii) a lead groove, wherein said lead groove has linear orientation to the movement direction of said linear piston leg.

5. The linear engine of claim 2, further comprising:
(f) a piston lowering driveshaft disposed on said lowering segmental cogwheel;
(g) a piston lowering driveshaft connective cogwheel disposed on said piston lowering driveshaft, wherein said lowering segmental cogwheel, said piston lowering driveshaft, and said piston lowering driveshaft connective cogwheel have a common rotational axis;
(h) a piston raising driveshaft disposed on said raising segmental cogwheel; and
(i) a piston raising driveshaft connective cogwheel disposed on said piston raising driveshaft, wherein said raising segmental cogwheel, said piston raising driveshaft, and said piston lowering raising connective cogwheel have a common rotational axis.

6. The linear engine of claim 5, further comprising:
(j) a rotational direction reversing cogwheel;
(k) a main driveshaft; and
(l) a flywheel, wherein said rotational direction reversing cogwheel, said main driveshaft, and said flywheel have a common rotational axis.

7. The linear engine of claim 6 further comprising:
(m) a transmission housing, including:
(i) a transmission housing front wall having a front opening, wherein said main driveshaft passes through said front opening;
(ii) a transmission housing rear wall connected to said transmission housing front wall, said transmission housing rear wall at least partially having an upper opening, wherein said linear piston leg passes through said upper opening;
(iii) a front transmission housing cover disposed on said transmission housing front wall; and
(iv) a rear transmission housing cover disposed on said transmission housing rear wall.

8. The linear engine of claim 7 further comprising:
(n) a cylinder disposed partially on said transmission housing front wall, and partially on said transmission housing rear wall.

9. The linear engine of claim 8 further comprising:
(o) a lead disposed on said rear transmission housing cover.
